(19) United States
(12) Patent Application Publication
(10) Pub. No.: US 2008/0028979 A1
(43) Pub. Date: Feb. 7, 2008

(54) Antifoulant Dispersant Composition and Method of Use

(75) Inventors: Joseph L. Stark, Richmond, TX (US); Roger D. Metzler, Sugar Land, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/832,308

(22) Filed: Aug. 1, 2007

Related U.S. Application Data
(60) Provisional application No. 60/835,298, filed on Aug. 3, 2006.

(51) Int. Cl. B05D 5/08

(52) U.S. Cl. 106/14.18; 427/427.7

(57) ABSTRACT

A dispersant can be used to prevent fouling in process equipment. The dispersant is particularly useful in applications such as the prevention of fouling of compressor blades in compressors used for ethylene production. The dispersant includes an admixture of isopropylhydroxyl amine and an N,N-dialkyl fatty acid amide. It is emphasized that this abstract is provided to comply with the rules requiring an abstract which will a searcher or other reader to quickly ascertain the subject matter of the technical disclosure. It is submitted with the understanding that it will not be used to interpret or limit the scope or meaning of claims. 37 CFR 1.72(b)

### CROSS REFERENCE TO RELATED APPLICATIONS

This application claims priority to the U.S. Provisional Patent Application having Ser. No. 60/835,298; that was filed on Aug. 3, 2006; the contents of which are fully incorporated herein by reference.

### BACKGROUND OF THE INVENTION

1. Field of the Invention

The present invention relates to an antifoulant dispersant. The present invention particularly relates to antifoulant dispersants for use with compressors.

2. Background of the Art

Fouling of compressors is a well-known problem in processes using them. The fouling of compressors can cause damage to the compressors as well as plant down time, both potentially very expensive problems. There has been considerable effort spent by industry to prevent such fouling. For example, U.S. Pat. No. 6,159,547 to McMordie, et al., discloses a method for coating turbomachinery having a metal surface to prevent fouling. The steps of the method are applying to the surface a first slurry containing an acidic aqueous medium containing a galvanically active material and phosphate ions, thereby forming a galvanically sacrificial first layer, curing the first layer, applying to the cured first layer an aqueous non-conductive second slurry containing inorganic phosphate or silicate ions, thereby forming a non-conductive second layer, curing the second layer, applying to the cured second layer a liquid sealer composition containing a thermally stable organic polymer and fluorocarbon, thereby forming a top layer, and curing the top layer.

In some processes, the operating conditions under which the compressors are laboring can foul or even erode compressor blades, no matter how well coated the compressor blades may be. For example, U.S. Pat. No. 5,849,983 to Khatib discloses addition of polyisobutylene to a predominantly gaseous stream for preventing the shearing of hydrocarbon droplets in the stream to aerosol sizes. One advantage of this invention is that when the polyisobutylene is sprayed upstream of compressor stations, it functions to prevent fouling and erosion of the compressor blades.

While a polymer can function to prevent fouling, as is disclosed in U.S. Pat. No. 5,849,983 to Khatib, in some processes, it is the formation of polymers that can cause fouling. For example, in an ethylene process, it is the formation of organic polymers that can cause compressor fouling.

Steam cracking of hydrocarbons accounts for virtually all of the ethylene produced worldwide. Hydrocarbons used as ethylene feedstocks range from natural gas liquids including ethane, propane and butane, to petroleum liquids including gas oils and naphtha. In the process of producing ethylene, as the ethylene is produced and purified, small amounts of polymers can form. These polymers are generally considered contaminants and are undesirable in the product ethylene. One point of isolation of such contaminants is the compressors. Due to pressure changes, the contaminants can be isolated as liquids and sent to knockout pots wherein the contaminants are held until sent for recycle or disposal.

### SUMMARY OF THE INVENTION

In one aspect, the present invention is an antifouling dispersant prepared from a formulation comprising isopropylhydroxyl amine, and an N,N-dialkyl fatty acid amide.

In another aspect, the present invention is a process for preventing fouling of a compressor used to compress gasses comprising depositing an antifouling dispersant onto one or more blades of a compressor to be protected from fouling, the antifouling dispersant being prepared from a formulation comprising isopropylhydroxyl amine and an N,N-dialkyl fatty acid amide.

In still another embodiment, the present invention is a process for preventing fouling of a compressor used to compress gasses comprising using an antifouling dispersant wash in a compressor to be protected from fouling, the antifouling dispersant being prepared from a formulation comprising isopropylhydroxyl amine and an N,N-dialkyl fatty acid amide.

Another embodiment of the invention is a process for preventing fouling of chemical production equipment comprising using an antifouling dispersant wash in at least one device to be protected from fouling, the antifouling dispersant being prepared from a formulation comprising isopropylhydroxyl amine and an N,N-dialkyl fatty acid amide.

### DESCRIPTION OF THE PREFERRED EMBODIMENTS

In one aspect, the present invention is a process for preventing fouling of compressor blades used to compress gasses. In the practice of the process of the present invention the dispersants can be applied to compressor blades in any way known to those of ordinary skill in the art of applying such materials to be useful for preventing fouling. In one embodiment, the additives are sprayed onto the compressor blades in the form of an aerosol. In another embodiment, the additives are injected into the gas stream being compressed, upstream of the compressor, as an aerosol that is then carried to the compressor blades by the gas being compressed. In still another embodiment, the additives are employed as part of a wash solution applied directly or indirectly to the compressor parts.

In another aspect, the invention is an antifoulant dispersant including isopropylhydroxyl amine (IPHA) and an N,N-dialkylamide of a fatty acid. This combination of components is hereinafter referred sometimes as dispersant or antifouling dispersant. The antifouling dispersant has the functionality of dispersing polymerized hydrocarbons and inhibiting the auto-polymerization of hydrocarbons thereby reducing polymers forming. The IPHA component of the antifouling dispersants functions to inhibit auto-polymerizations. The N,N-dialkylamide component acts to disperse hydrocarbons and polymers and has a general formula:

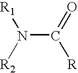

wherein:
R₁ and R₂ are the same or different and are alkyl groups having from one to four carbons; and
R is an alkyl or alkenyl group having from 9 to 30 carbons.

Typically, R is an alkenyl group having one or more unsaturated bonds and having from 12 to 20 carbons. The N,N-dialkylamide may be a single compound but in some embodiments is a mixture of compounds. For example, in one embodiment the N,N-dialkylamide used to prepare the dispersant of the invention is DMAD which is available from Buckman Laboratories of Canada, Ltd., Vaudreuil, Quebec, Canada. The DMAD products are believed to consist primarily of a mixture of two N,N-dialkylamides having the formulae:

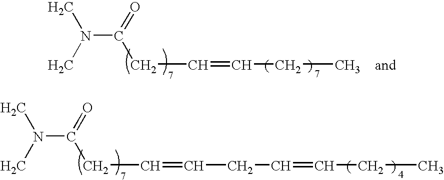

along with a minor amount of similar saturated compounds.

The two components of the dispersants of the present invention may be brought together in ratios of IPHA to N,N-dialkyl fatty acid amides in weight ratios ranging from 10:1 to 1:10. In some embodiments this ratio may be from 1:1 to 1:10. In other embodiments, this ratio may be from 1:1 to 1:2. All points intermediate in these ranges is also within the scope of the present invention.

While the dispersants may be used or applied neat, in one embodiment of the invention, the dispersant is prepared using a solvent. The solvents which are useful with the present invention include any solvent in which: a) the IPHA and N,N-dialkylamide of a fatty acid are soluble or can be stably suspended and b) the resulting solution or suspension is miscible with water at a concentration of at least 100 weight ppm of solution or suspension in water. Exemplary solvents include, but are not limited to benzyl alcohol, 2-phenoxyethanol, 2-(methoxymethoxy)ethanol, 2-butoxyethanol, 2-(isopentyloxy)ethanol, 2-(hexyloxy)ethanol, diethylene glycol, diethylene glycol monomethyl ether, diethylene glycol monoethyl ether, diethylene glycol monobutyl ether, triethylene glycol, triethylene glycol monomethyl ether, liquid polyethylene glycol, 1-methoxy-2-propanol, 1-ethoxy-2-propanol, dipropylene glycol, dipropylene glycol monomethyl ether, dipropylene glycol monoethyl ether, and a low molecular weight polypropylene glycol. Commercial solvents such as Butyl Carbitol and Butyl CELLOSOLVE™, which consists primarily of and Butyl CARBITOL™, which consists primarily of ethylene glycol monobutyl ether may be used and are available from DOW.

When a solvent is present, it may be present in a weight ratio of solvent to dispersant of from about 4:1 to about 1:1.

The components of the dispersants may be brought together in any way that is known to be useful to those of ordinary skill in preparing chemical compositions for industrial use. For example, the components may be admixed sequentially or all at once. The dispersants of the invention may be prepared using a batch process or they may be prepared using a continuous process.

The dispersants of the present invention have a useful synergy, the mixed components performing better together than the individual components singularly.

While the dispersants of the present invention are effective at preventing compressor fouling, there is a second property of these dispersants that is also desirable. The dispersants of the invention have the desirable property of not creating emulsions with resultant foaming in, for example, knockout pots. Knockout pots are used most applications where a compressor is employed and is often a point where dispersants may accumulate. While the dispersant of the invention may not act to break existing emulsions, they do not of themselves cause emulsions, unlike many other dispersants used for preventing compressor fouling.

While the dispersants of the present invention are useful in compressors used for an ethylene process production process, they are also useful in other similar applications and with other equipment. For example, the dispersants of the invention may be used with any process where process equipment will come into contact with ethylene cracked gassed. Another application of the invention is ethylene and acrylonitrile quench water systems. The dispersants of the application may be used with ethylene dilution steam generators and acrylonitrile purification systems. Many polymer processes have monomer recovery systems which are subject to fouling and are good target applications for the dispersants of the invention. Process water strippers and waste water strippers used with petrochemical processes such as styrene, butadiene, acrylonitrile, and ethylene processes are potential applications for the dispersants of the invention. Finally, ethylene acid gas scrubbers and butadiene solvent recovery systems are also end use applications of the dispersants of the present invention. The dispersants can be desirably used in any process which has process equipment subject to fouling with polymers. The dispersants are especially desirable in applications where foaming would problematic. In addition to processes that consume or produce at least one of styrene, butadiene, acrylonitrile, and ethylene are potential applications of the dispersants.

For the purposes of the present application, the term process equipment means compressors, fans, impellers, pumps, vacuum pumps, valves, heat exchangers; sensors, and the like, that are associated with the process and which may be subject to fouling. This term also includes supersets of these components where more than one of the components is part of a “system” such as, for example, a stripper where hydrocarbons are removed from an aqueous process stream, or a knockout pot.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

A dispersant of the present invention is prepared by admixing 7.5 parts IPHA, 10 parts DMAD (a fatty acid dimethylamide available from Buckman Laboratories of Canada), 40 parts Butyl CARBITOL, and 42.5 parts water.

The dispersant is tested according to ASTM-873 also known as the induced gums test. This test method determines the tendency of a hydrocarbon to form gums under accelerated aging conditions. In this method 100 ml of a hydrocarbon is placed into a bomb and air is introduced to attain a pressure of about 100 psi (689 kPa). The bomb is then kept at 100° C. for four hours. After the completion of the test, bomb is cooled rapidly and the pressure is released slowly. The liquid phase of the sample is evaporated 160° C. under a nitrogen purge for 30 minutes then at about 220° C. under a steam purge for 30 minutes. The value of potential gum is determined using weight differentials. The dispersant is tested at a concentration of 100 ppm. A control is prepared and tested wherein no dispersant is included in the hydrocarbon.

The results are shown below in Table 1

### Example 2

Example 1 is repeated substantially identically except that the dispersant is prepared by admixing 6 parts IPHA, 20 parts DMAD, 40 parts Butyl CARBITOL, and 34 part of water.

TABLE 1

| | Gums Produced | Percent |
|---|---|---|
| Sample ID | (mg/100 ml) | Reduction |
| Control* | 355.6 | — |
| Example 1 | 328.4 | 7.6 |
| (Dispersant I) | | |
| Example 2 | 327.4 | 7.9 |
| (Dispersant II) | | |

*Not an example of the invention.

### Example 3

The dispersant prepared in Example 1 (Dispersant I) is tested according to the following procedure.

100 ml of a hydrocarbon is placed into a bomb and nitrogen is introduced to attain a pressure of about 100 psi (689 kPa). The bomb is then kept at 100° C. for four hours. After the completion of the test, bomb is cooled rapidly and the pressure is released slowly. The liquid phase of the sample is evaporated 160° C. under a nitrogen purge for 30 minutes then at about 220° C. under a steam purge for 30 minutes. The value of potential gum is determined using weight differentials. The dispersant is tested at a concentration of 12 ppm. A control is prepared and tested wherein no dispersant is included in the hydrocarbon.

The results are shown below in Table 2.

### Example 4

Example 3 is repeated substantially identically except that the dispersant is tested at 25 ppm.

The results are shown below in Table 2.

### Comparative Example A

Example 3 is repeated substantially identically except that diethylhydroxyl amine (DEHA) is used (Dispersant III) instead of IPHA.

The results are shown below in Table 2.

### Comparative Example B

Example 3 is repeated substantially identically except that Dispersant III is used at a concentration of 25 ppm.

The results are shown below in Table 2.

### Comparative Example C

Example 3 is repeated substantially identically except that the dispersant is IPHA alone and it is used at a concentration of 1.875 ppm.

The results are shown below in Table 2.

### Comparative Example D

Example 3 is repeated substantially identically except that the dispersant is DMAD alone and it is used at a concentration of 2.5 ppm.

The results are shown below in Table 2.

TABLE 2

| | | Percent Reduction |
|---|---|---|
| Sample ID | Concentration (ppm) | of Gums |
| Example 3 | 12 | 53 |
| (Dispersant I) | | |
| Example 4 | 25 | 38 |
| (Dispersant I) | | |
| Comparative Example A* | 12 | −8\hat{ } |
| (Dispersant III) | | |
| Comparative Example B* | 25 | −36\hat{ } |
| (Dispersant III) | | |
| Comparative Example C* | 1.875^{#} | −70\hat{ } |
| IPHA alone | | |
| Comparative Example D* | 2.5^{##} | −35\hat{ } |
| DMAD alone | | |

*Not an example of the invention.
\hat{ }A negative reduction indicates that the gum concentration increased over the blank.
^{#}Represents the level of IPHA found in Example 4.
^{##}Represents the level of DMAD found in Example 4.

What is claimed is:

1. An antifouling dispersant comprising:
isopropylhydroxyl amine, and
an N,N-dialkyl fatty acid amide.

2. The antifouling dispersant of claim 1 wherein the N,N-dialkyl fatty acid amide has a general formula: 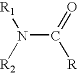
wherein:
R₁ and R₂ are the same or different and are alkyl groups having from one to four carbons; and
R is an alkyl or alkenyl group having from 9 to 30 carbons.

3. The antifouling dispersant of claim 2 wherein R is an alkyl or alkenyl group having from 12 to 20 carbons.

4. The antifouling dispersant of claim 1 wherein the N,N-dialkyl fatty acid amide is a single compound.

5. The antifouling dispersant of claim 1 wherein the N,N-dialkyl fatty acid amide is a mixture of compounds.

6. The antifouling dispersant of claim 5 wherein the N,N-dialkyl fatty acid amide is a mixture of compounds, the two primary compounds having the formulas of:

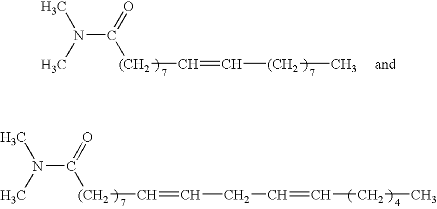

7. The antifouling dispersant of claim 1 wherein the weight ratio of isopropylhydroxyl amine to N,N-dialkyl fatty acid amides is from 10:1 to 1:10.

8. The antifouling dispersant of claim 8 wherein the weight ratio of isopropylhydroxyl amine to N,N-dialkyl fatty acid amides is from 1:1 to 1:2.

9. The antifouling dispersant of claim 1 wherein the antifouling dispersant is dissolved in a solvent.

10. The antifouling dispersant of claim 10 wherein the solvent is selected from the group consisting of: benzyl alcohol, 2-phenoxyethanol, 2-(methoxymethoxy)ethanol, 2-butoxyethanol, 2-(isopentyloxy)ethanol, 2-(hexyloxy)ethanol, diethylene glycol, diethylene glycol monomethyl ether, diethylene glycol monoethyl ether, diethylene glycol monobutyl ether, triethylene glycol, triethylene glycol monomethyl ether, liquid polyethylene glycol, 1-methoxy-2-propanol, 1-ethoxy-2-propanol, dipropylene glycol, dipropylene glycol monomethyl ether, dipropylene glycol monoethyl ether, molecular weight polypropylene glycol, and mixtures thereof.

11. The antifouling dispersant of claim 10 wherein the solvent is present in a weight ratio of solvent to antifouling dispersant of from about 4:1 to about 1:1.

12. A process for preventing fouling of a compressor used to compress gasses comprising depositing an antifouling dispersant onto one or more blades of a compressor to be protected from fouling, the antifouling dispersant being prepared from a formulation comprising isopropylhydroxyl amine and an N,N-dialkyl fatty acid amide.

13. The process of claim 13 wherein the N,N-dialkyl fatty acid amide has a general formula: 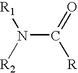
wherein:
R₁ and R₂ are the same or different and are alkyl groups having from one to four carbons; and
R is an alkyl or alkenyl group having from 9 to 30 carbons.

14. The process of claim 13 wherein the antifoulant dispersant is sprayed onto the compressor blades in the form of an aerosol.

15. The process of claim 13 wherein the antifoulant dispersant is injected into a gas stream being compressed, upstream of the compressor, as an aerosol that is then carried to the compressor blades by the gas being compressed.

16. A process for preventing fouling of a compressor used to compress gasses comprising employing an antifouling dispersant wash in a compressor to be protected from fouling, the antifouling dispersant being prepared from a formulation comprising isopropylhydroxyl amine and an N,N-dialkyl fatty acid amide.

17. The process of claim 17 wherein the N,N-dialkyl fatty acid amide has a general formula: 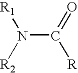
wherein:
R₁ and R₂ are the same or different and are alkyl groups having from one to four carbons; and
R is an alkyl or alkenyl group having from 9 to 30 carbons.

18. A process for preventing fouling of chemical production equipment comprising employing an antifouling dispersant wash in at least one device to be protected from fouling, the antifouling dispersant being prepared from a formulation comprising isopropylhydroxyl amine and an N,N-dialkyl fatty acid amide.

19. The process of claim 19 wherein the chemical production equipment is selected from the group comprising: equipment used for ethylene cracked gas; equipment used for ethylene quench water; equipment used for acrylonitrile quench water; equipment used for ethylene dilution steam generation; equipment used for acrylonitrile purification; equipment used for monomer recovery; process water strippers; waste water strippers; ethylene acid gas scrubbers; equipment used for butadiene solvent recovery; a monomer recovery system; and a process water stripper.

20. The process of claim 19 wherein the chemical production equipment is part of a petrochemical production process selected from the group consisting of styrene, butadiene, acrylonitrile, and ethylene production processes.

21. The process of claim 19 wherein the chemical production equipment is part of a petrochemical production process which consumes a chemical selected from the group consisting of styrene, butadiene, acrylonitrile, and ethylene.
